(19) United States
(12) Patent Application Publication
(10) Pub. No.: US 2013/0055335 A1
(43) Pub. Date: Feb. 28, 2013

(54) SECURITY ENHANCEMENT METHODS AND SYSTEMS

(71) Applicant: Shih-Wei Chien, Hsinchu City (TW)

(72) Inventor: Shih-Wei Chien, Hsinchu City (TW)

(21) Appl. No.: 13/215,224

(22) Filed: Aug. 22, 2011

(51) Int. Cl. H04L 9/32; G06F 17/00

(52) U.S. Cl. 726/1; 726/3; 726/5

(57) ABSTRACT

In accordance with at least some embodiments of the present disclosure, a security enhancement method is provided for operating a computer system having a trusted environment and an untrusted environment. The method may include acquiring an identification data associated with an application installed in the untrusted environment, authenticating the identification data according to a predetermined rule in the trusted environment to acquire a corresponding authentication result, and executing the application in the untrusted environment or uninstalling the application from the computer system according to the authentication result.

### BACKGROUND

Unless otherwise indicated herein, the approaches described in this section are not prior art to the claims in this application and are not admitted to be prior art by inclusion in this section.

As the popularity of mobile devices increases and as more ways have been devised to allow such mobile devices to communicate with one another and with other digital devices, there is a growing need to adequately protect important, confidential, and/or personal data that may be stored in all digital devices. Generally, software applications may be executed by digital devices that support environments of different security levels. An untrusted environment may offer normal security level services, such as for making a phone call and playing java games on such digital devices. A trusted environment may offer high security level services, such as e-commerce applications or digital-rights-management (DRM) applications, so that confidential and/or restricted information on such digital devices may not be leaked and/or tampered with. While the trusted environment conventionally aims to improve data security by using various techniques such as cryptography, there is currently inadequate protection against malicious attacks in the untrusted environment. Therefore, there is a general need to improve data security in digital devices.

### SUMMARY

In at least some embodiments of the present disclosure, a method of providing services in a computer system having a trusted environment and an untrusted environment is provided. The method includes acquiring an identification data associated with an application installed in the untrusted environment, authenticating the identification data according to a predetermined rule in the trusted environment to acquire a corresponding authentication result, and executing the application in the untrusted environment or uninstalling the application from the computer system according to the authentication result.

In at least some embodiments of the present disclosure, a computer system configured to provide services in an untrusted environment and a trusted environment is provided. The computer system includes a scan stub module configured to detect a system event associated with an installation of an application in the untrusted environment, acquire an identification data associated with the application, and request the installation of the application to be authenticated in the trusted environment, a scan service module configured to authenticate the identification data in the trusted environment according to a predetermined rule and acquire a corresponding authentication result, and a processor configured to execute the application in the untrusted environment or uninstalling the application from the computer system according to authentication result.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a flowchart of an illustrative embodiment of a method for providing services in a computer system having an untrusted environment and a trusted environment.

FIG. 1B is a flowchart of an illustrative embodiment of a method for updating a predetermined rule in a computer system having an untrusted environment and a trusted environment.

FIG. 2 is an illustrative embodiment of a computer system configured to execute the methods of FIG. 1 and/or FIG. 2.

FIG. 3 is another illustrative embodiment of a computer system configured to execute the methods of FIG. 1 and/or FIG. 2.

FIG. 4 is a diagram of an illustrative embodiment of a predetermined rule.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

A computer system may support a trusted environment and an untrusted environment. High security level services may be offered, supported, and/or operated in the trusted environment of a computer system, and normal security level services may be offered, supported, and/or operated in the untrusted environment. Throughout the present disclosure, the term “service” may broadly refer to, without limitation, an operation of executing, installing, un-stalling, scanning, auditing, or authenticating an application. In the trusted environment, the computer system may be configured to behave in expected ways. To have predictable behavior, hardware resources (e.g., protected storage/memory, cryptographic block, and others) and software resources (cryptographic block, secure boot loader, secure operation systems/applications, and others) may be utilized. At least one function of the trusted environment is to ensure the execution of authorized code on the computer system.

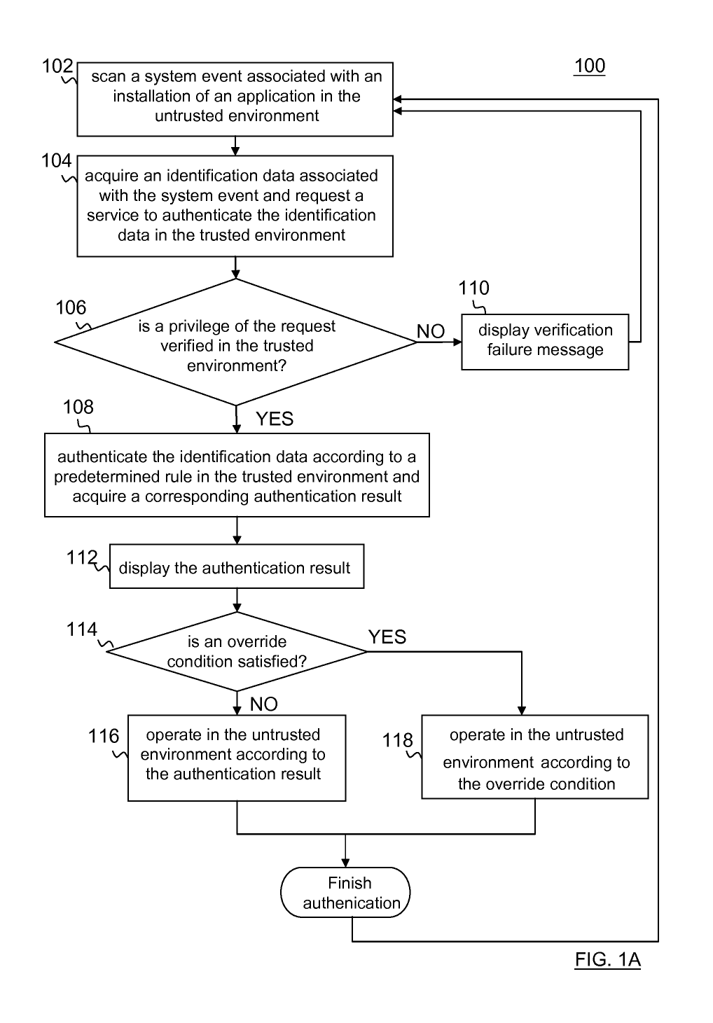

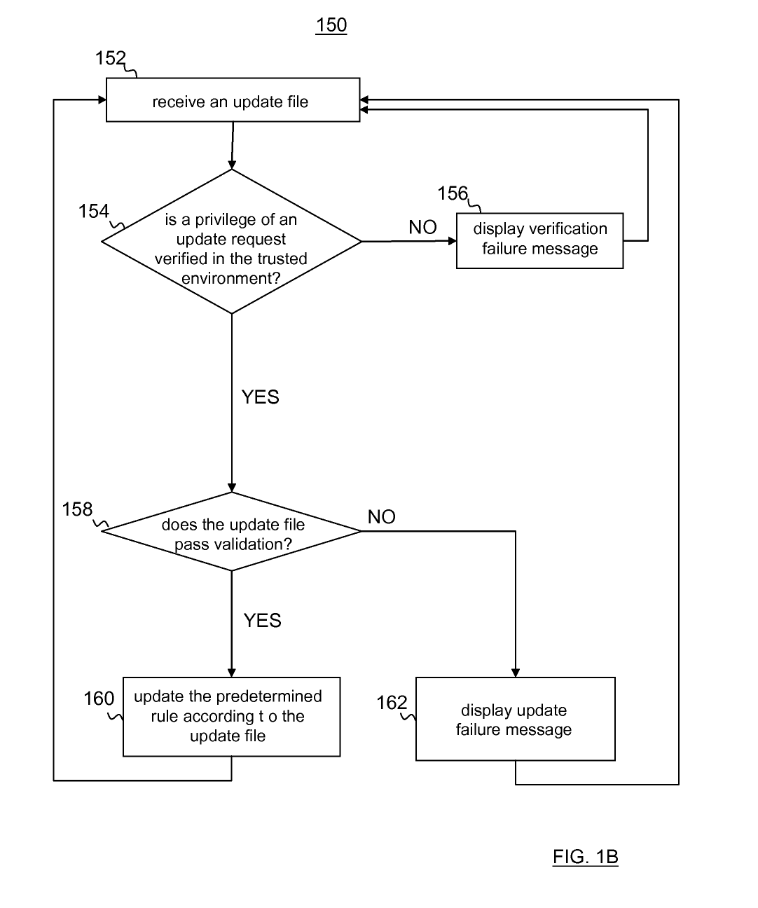

FIG. 1A is a flowchart of an illustrative embodiment of a method 100 for providing services in a computer system having an untrusted environment and a trusted environment in accordance with the present disclosure. Method 100 may include one or more operations, functions or actions as illustrated by one or more of blocks 102, 104, 106, 108, 110, 112, 114, 116, and/or 118. The various blocks may be combined into fewer blocks, divided into additional blocks, and/or eliminated based upon the desired implementation. Processing for method 100 may begin at block 102, “scan a system event associated with an installation of an application in the untrusted environment.” Block 102 may be followed by block 104, “acquire an identification data associated with the system event and request a service to authenticate the identification data in the trusted environment”. Block 104 may be followed by decision block 106, “is a privilege of the request verified in the trusted environment?” If the privilege of the request is indeed verified, decision block 106 may be followed by block 108, “authenticate the identification data according to a predetermined rule in the trusted environment and acquire a corresponding authentication result”. If the privilege of the request fails to be verified, decision block 106 may be followed by block 110, “display verification failure message.” After block 110, method 100 may loop back to block 102.

Block 108 may be followed by block 112, “display the authentication result.” Block 112 may be followed by decision block 114, “is an override condition satisfied?” If the override condition is not satisfied, decision block 114 may be followed by block 116, “operate in the untrusted environment according to the authentication result.” If the override condition is satisfied, decision block 114 may be followed by block 118, “operate in the untrusted environment according to the override condition.” After authentication is finished, method 100 may loop back to block 102.

FIG. 1B is a flowchart of an illustrative embodiment of a method 150 for updating a predetermined rule in a computer system having an untrusted environment and a trusted environment in accordance with the present disclosure. Method 150 may include one or more operations, functions or actions as illustrated by one or more of blocks 152, 154, 156, 158, 160, and/or 162. The various blocks may be combined into fewer blocks, divided into additional blocks, and/or eliminated based upon the desired implementation. Processing for method 150 may begin at block 152, “receive an update file.” Block 152 may be followed by decision block 154, “is a privilege of an update request verified in the trusted environment?” If the privilege of the update request fails to be verified, decision block 154 may be followed by block 156, “display verification failure message.” After block 156, method 150 may loop back to block 152.

If the privilege of the update request is indeed verified, decision block 154 may be followed by decision block 158, “does the update file pass validation?” If the update file indeed passes validation, decision block 158 may be followed by block 160, “update the predetermined rule according to the update file”. If the update file fails validation, decision block 158 may be followed by block 162, “display update failure message”. After block 160 or block 162, method 150 may loop back to block 152.

In an embodiment, method 100 and method 150 may correspond to independent tasks that are executed in the computer system. In another embodiment, methods 100 and 150 may be combined in the same task.

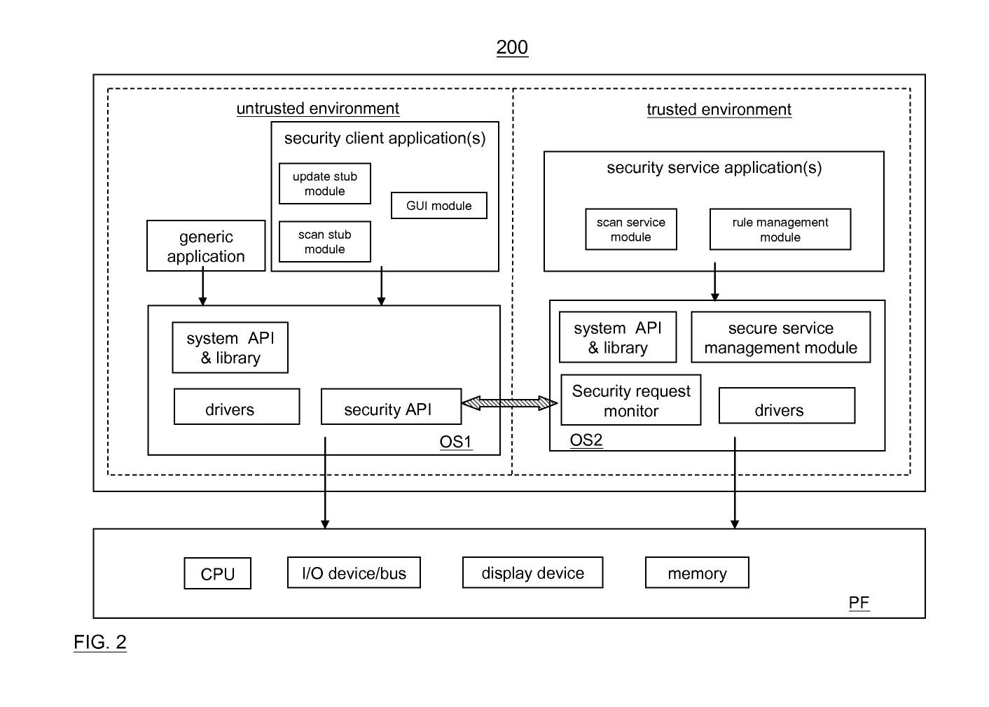

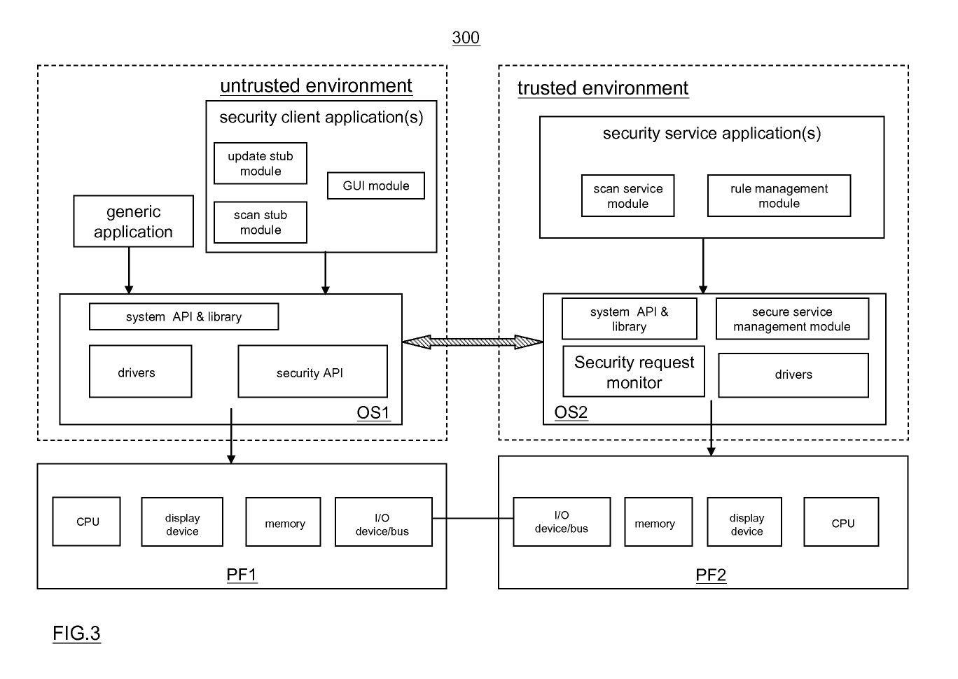

FIG. 2 is an illustrative embodiment of a computer system 200 configured to execute method 100 and/or method 150 in accordance with the present disclosure. FIG. 3 is another illustrative embodiment of a computer system 300 also configured to execute method 100 and/or method 150 in accordance with the present disclosure. The examples computer systems 200 and 300 are designed to support architectures capable of operating in either a trusted environment or an untrusted environment, such as, without limitation, the TrustZone® hardware architecture developed by ARM. The security of the computer systems 200 and 300 is based on the partitioning of the hardware and software resources into one of two environments—the trusted environment and the untrusted environment. Example applications, such as, without limitation, generic applications and security client applications, may be executed in the untrusted environment. Example applications, such as, without limitation, security service applications, may be executed in the trusted environment.

In FIG. 2, one embodiment of the computer system 200 may include two operational systems OS1˜OS2 and a hardware platform PF, such as, without limitation, a TrustZone® enabled hardware platform. The operational system OS1 may include a security application program interface (API), a system API& library, and drivers for the generic applications and security client applications to operate in the untrusted environment. The operational system OS2 may include a security request monitor, the system API & library, a secure service management module, and drivers for the security service applications to operate in the trusted environment. The security API and the security request monitor may be configured to allow the computer system 200 to switch between operating in the untrusted environment and operating in the trusted environment in a time-sliced fashion. In one embodiment, the security API may be utilized, so that the resources in the untrusted environment may be accessed. The security request monitor, on the other hand, may be utilized to monitor incoming request commands and/or data from the untrusted environment to the trusted environment.

The hardware platform PF in the computer system 200 may provide resources that an application utilizes to perform its functions. Such resources may include, without limitation, CPU, I/O device/bus, display device, memory, and other hardware modules. In some embodiments, certain devices in the hardware platform PF may be accessed by applications in both the trusted environment and the untrusted environment. Some other devices or part of the devices in the hardware platform PF may be dedicated to executing codes in the trusted environment. For example, the input device (such as keypad) and the display device (such as screen) may be accessible in both the trusted environment and the untrusted environment. On the other hand, a particular portion of the memory may only be accessible in the trusted environment.

The operational system OS1 in the computer system 200 may be configured to manage the resources of the hardware platform PF for executing the generic application and security applications in the untrusted environment. An example security client application of the untrusted environment may be implemented using software functional modules, which may include a scan stub module, an update stub module, and a graphic user interface (GUI) module.

The operational system OS2 of the computer system 200 may be configured to manage the resources of the hardware platform PF for executing the security service applications in the trusted environment. An example security service application of the trusted environment may be implemented using software functional modules, which may include a scan service module and a rule management module.

In FIG. 3, one embodiment of the computer system 300 may include two operational systems OS1˜OS2 and two hardware platforms PF1˜PF2. The first hardware platform PF1 may provide resources that an application utilizes to perform its functions in the untrusted environment of the computer system 300. Such resources may include, without limitation, CPU, display device, I/O bus/device, memory, and other hardware modules. The second hardware platform PF2 may also provide hardware resources that an application utilizes to perform its functions in the trusted environment the computer system 300. Such resources may include, without limitation, CPU, display device, I/O bus/device, memory, and other hardware modules. The first hardware platform PF1 may be a SoC of a digital device. The second hardware platform PF2 may be a USB dongle. The first hardware platform PF1 and the second hardware platform PF2 may be connected to each other via an USB interface/bus.

The operational system OS1 in the computer system 300 may include a security API for accessing security services and a system API & library and drivers which are configured to manage the resources of the hardware platform PF1 for executing the generic application and security applications in the untrusted environment. An example security client application of the untrusted environment may be implemented using software functional modules which may include, without limitation, a scan stub module, an update stub module, and a GUI module.

The operational system OS2 in the computer system 300 may include a security request monitor, a system API & library, a secure service management module, and drivers which are configured to manage the resources of the hardware platform PF2 for executing the security service applications in the trusted environment. An example security service application of the trusted environment may be implemented using software functional modules which may include, without limitation, a scan service module and a rule management module.

Referring to FIGS. 1A, 1B, 2, and 3, the security client application in the untrusted environment may be configured to execute one or more of blocks 102, 104, 110, 112, 116, 118, 152, 156 and 162. For example, blocks 102 and 104 may be executed by the scan stub module. Blocks 110, 112, 156 and 162 may be executed by the GUI module. Blocks 116, 118 may be executed by the CPU. Block 152 and 160 may be executed by the update stub module.

The security service application in the trusted environment may be configured to execute one or more of blocks 106, 108, 114, 152, 154, 158 and 160. For example, blocks 106 and 114, 154 and 158 may be executed by the secure service management module. Block 108 may be executed by the scan service module. Block 152 and 160 may be executed by the rule management module.

As an illustration, in block 102, the scan stub module may be configured to detect a system event associated with an installation of the application in the untrusted environment of the computer system 200 or 300. Some example system events may include, without limitation, a complete notice of a boot-up sequence during which an application is installed in the computer system 200 or 300, an installation complete notice of an application, or a user request for scanning an installed application.

In block 104, upon detecting such a system event, the scan stub module may be further configured to scan the detected system event, thereby acquiring a corresponding identification data. The scan stub module may then send the identification data to the scan service module and request a service to authenticate the identification data in the trusted environment. The identification data may be meta data, which may include hash identification (a hash value produced by cryptographic hash function such as MD5 message-digest algorithm), partial/full name of the application, size of the application, partial content of the application, writer/publisher signature of the application, or manifest of the application. The identification data also may be the full content of the application.

In decision block 106, the secure service management module may be configured to verify the privilege of the request in the trusted environment according to the login credential of the computer system 200 or 300 after having detected the system event in the untrusted environment. In other words, the service shown in block 108 and requested in block 104 may be performed when, for instance, the requester, associated with the login credential of the computer system 200 or 300 and making the request, is determined to have proper authorization. Otherwise, a verification failure message may be displayed on the GUI module in block 110.

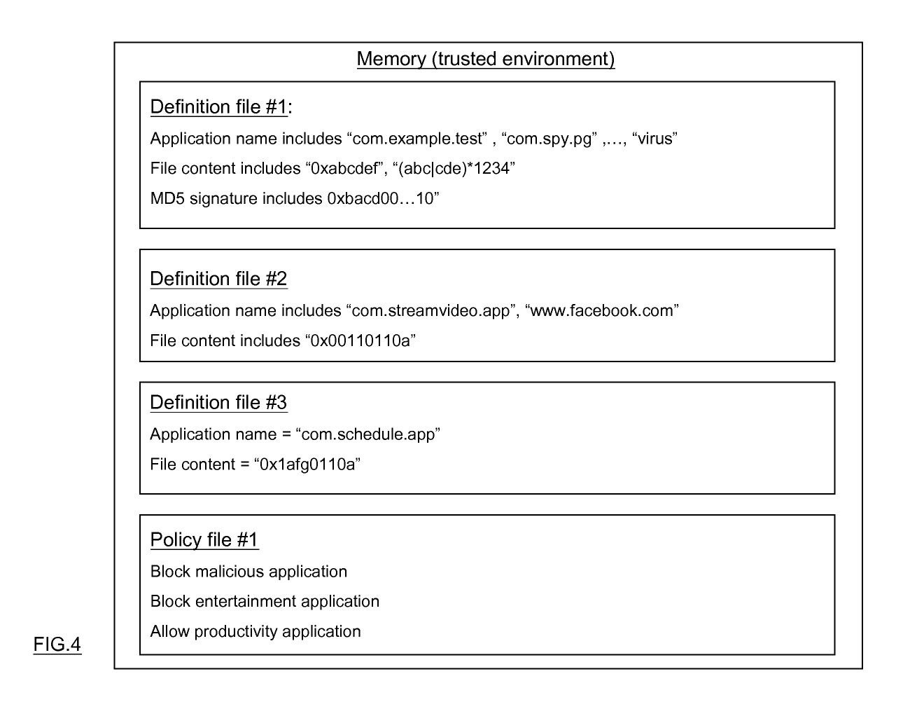

For executing block 108, the predetermined rule may be stored in the memory of the trusted environment to avoid being hacked or tampered with. In an embodiment of the present disclosure, the predetermined rule may include various definitions files and a policy file, as depicted in FIG. 4. Each definition file may include features of a specific type of applications, and the policy file may include instructions to allow certain types of applications to be installed or prevent certain types of applications from being installed in the untrusted environment. For example, the definition file #1 may include features for identifying known malicious applications, the definition file #2 may include features for identifying entertainment applications, the definition file #3 may include features for identifying productivity applications, and the policy file #1 may include instructions of blocking malicious/entertainment applications but allowing productivity applications.

In block 108, the identification data may be authenticated by the scan service module in the trusted environment according to the predetermined rule. In block 112, the corresponding authentication result may be displayed on the GUI module in the untrusted environment.

In block 114, the override condition may be satisfied upon the receipt of an override command, if the command is determined to come from a legitimate source and if the authentication result has been acquired. In one embodiment, the secure service management module may be configured to verify the credentials of the issuer of the override command in the trusted environment. In another embodiment, the computer system 200 or 300 may be configured to automatically verify the current login information received by the computer system 200 or 300 when the application, as determined in block 108, is not allowed according to the predetermined rule. The override condition may be satisfied if the current login information is a password with the validated credentials (e.g., a password entered by a supervisor, who is authorized to override certain conditions).

In block 116, the computer system 200 or 300 may proceed to operate in the untrusted environment according to the authentication result. For example, if it is determined in block 108 that the application is allowed according to the predetermined rule and the override condition is not satisfied in block 114, the computer system 200 or 300 may keep the application installed in the untrusted environment, or proceed to execute the application. If it is determined in block 108 that the application should be blocked according to the predetermined rule and the override condition is not satisfied in block 114, the computer system 200 or 300 may uninstall the application.

In block 118, the computer system 200 or 300 may proceed to operate in the untrusted environment according to the override condition. For example, if it is determined in block 108 that the application should be blocked according to the predetermined rule and an override command is inputted via the GUI module from an issuer whose credential has been verified in block 114, the computer system 200 or 300 may keep the application installed in the untrusted environment, or proceed to execute the application. If it is determined in block 108 that the application is allowed according to the predetermined rule and an override command is inputted via the GUI module from an issuer whose credential has been verified in block 114, the computer system 200 or 300 may uninstall the application.

In block 152, the computer system 200 or 300 may receive the update file from a remote server. Block 152 may be executed periodically or based on a demand from a user.

In decision block 154, the secure service management module may be configured to verify the privilege of an update request in the trusted environment. Such an update request may be embedded in the update file received in block 152 or in an independent request from a user, the computer system 200, or the computer system 300. In other words, the services shown in block 158 may be performed when, for instance, the requester of the update request is determined to have proper authorization. Otherwise, a verification failure message may be displayed on the GUI module in block 156.

In decision block 158, the rule management module may be configured to validate the correctness and integrity of the update file (such as by means of cryptography). In other words, the service shown in block 160 may be performed when, for instance, the update file is determined to have proper contents or format. Otherwise, an update failure message may be displayed on the GUI module in block 162.

In method 150, updating the predetermined rule may involve both of the trusted and untrusted environments, or only the trusted environment. In one embodiment, the update stub module in the untrusted environment may be activated periodically or on demand from a user, receive update files from a remote server, and transfer the update files to the rule management module in the trusted environment. The rule management module may be configured to validate the correctness and integrity of the update files (such as by means of cryptography) and update the predetermined rule accordingly if the validation passes.

In another embodiment, the rule management module in the trusted environment may receive update files directly from a remote server, periodically or on demand from a user. The rule management module may be configured to validate the correctness and integrity of the update files (such as by means of cryptography) and update the predetermined rule accordingly if the validation passes. In such embodiments in which updating the predetermined rule occurs in the trusted environment, the update stub module depicted in FIG. 2 and FIG. 3 may be optional.

The computer systems 200 and 300 according to the present disclosure may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computer systems 200 and 300 may also be implemented as a personal computer including both laptop computer and non-laptop computer configurations.

There is little distinction left between hardware and software implementations of aspects of various modules in the computer system 200 or 300; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. Those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or firmware to implement the techniques introduced here may be stored on a non-transitory machine-readable storage medium and may be executed by one or more general-purpose or special-purpose programmable processors. For example, the machine-executable instructions for method 100 of FIG. 1A, the machine-executable instructions for method 150 of FIG. 1B, and the definition files and the policy file of FIG. 4 may be stored in memory, accessed and/or executed by one or more platforms of illustrated computer systems 200 or 300 of FIG. 2 and FIG. 3. A “machine-readable storage medium”, as the term is used herein, includes any mechanism that provides (i.e., stores and/or transmits) information in a form accessible by a machine (e.g., a computer, network device, personal digital assistant (PDA), mobile device, tablet, manufacturing tool, any device with a set of one or more processors, etc.). For example, a machine-accessible storage medium includes recordable/non-recordable media (e.g., read-only memory (ROM), random access memory (RAM), magnetic disk storage media, optical storage media, flash memory devices, etc.)

Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense.

I claim:

1. A method of providing services in a computer system having a trusted environment and an untrusted environment, comprising:
acquiring an identification data associated with an application installed in the untrusted environment;
authenticating the identification data according to a predetermined rule in the trusted environment to acquire a corresponding authentication result; and
executing the application in the untrusted environment or uninstalling the application from the computer system according to the authentication result.

2. The method of claim 1, wherein the authenticating the identification data is performed after having detected a system event associated with an installation of the application in the untrusted environment.

3. The method of claim 2, wherein the system event includes a notice of completing a boot-up sequence during which the application is installed in the computer system, a notice of completing the installation of the application, or a request for scanning the application.

4. The method of claim 2, further comprising:
prior to the authenticating the identification data, obtaining a login credential of the computer system after having detected the system event;
requesting a service to authenticate the identification data in the trusted environment; and
performing the service after having verified a privilege of the login credential.

5. The method of claim 1, wherein the identification data is a meta data, a partial name of the application, or a partial file content of the application.

6. The method of claim 1, further comprising:
storing a definition file and a policy file as the predetermined rule in the trusted environment, wherein the definition file includes a feature associated with a type of applications, and the policy file includes an instruction to allow the type of applications to be installed or prevent the type of applications from being installed in the trusted environment.

7. The method of claim 6, wherein the authenticating the identification data further comprises:
comparing the identification data with the definition file to determine whether the application belongs to the type of applications; and
determining whether installing the application complies with the instruction of the policy file if the application belongs to the type of applications.

8. The method of claim 5, further comprising:
storing a policy file as the predetermined rule in the trusted environment, wherein the policy file includes a first instruction to allow a first feature supported by a first application or a second instruction to block a second feature supported by a second application.

9. The method of claim 8, wherein the authenticating the identification data according to the predetermined rule further comprises:
determining whether installing the application complies with the first and second instructions of the policy file.

10. The method of claim 1, further comprising:
receiving a file for updating the predetermined rule;
validating a content of the file in the trusted environment; and
based on a result of the validation, updating the predetermined rule according to the file in the trusted environment.

11. The method of claim 1, further comprising:
after having detected an override command in the untrusted environment, verifying credentials of an issuer of the override command in the trusted environment;
based on a failure of the verification, executing the application in the untrusted environment or uninstalling the application from the computer system according to the authentication result; and
based on a success of the verification, executing the application in the untrusted environment or uninstalling the application from the computer system according to the override command.

12. The method of claim 1, further comprising sending a request from the trusted environment to the untrusted environment for a system event associated with an installation of the application in the untrusted environment.

13. A computer system configured to provide services in an untrusted environment and a trusted environment, comprising:
a scan stub module configured to detect a system event associated with an installation of an application in the untrusted environment, acquire an identification data associated with the application, and request the installation of the application to be authenticated in the trusted environment;
a scan service module configured to authenticate the identification data in the trusted environment according to a predetermined rule and acquire a corresponding authentication result; and
a processor configured to execute the application in the untrusted environment or uninstalling the application from the computer system according to authentication result.

14. The computer system of claim 13, further comprising:
a graphic user interface (GUI) configured to display the authentication result.

15. The computer system of claim 13, further comprising:
a memory for storing the predetermined rule in the trusted environment; and
a rule management module configured to retrieve the predetermined rule from the memory, receive a file for updating the predetermined rule, validate the file, and update the predetermined rule according to the file based on a result of the validation.

16. The computer system of claim 15, further comprising:
an update stub module configured to receive the file for updating the predetermined rule in the untrusted environment.

17. A machine-readable medium having a set of instructions which, when executed by a processor, causing the processor to perform a method of providing services in a computer system having a trusted environment and an untrusted environment, the method comprising:
acquiring an identification data associated with an application installed in the untrusted environment;
authenticating the identification data according to a predetermined rule in the trusted environment to acquire a corresponding authentication result; and
executing the application in the untrusted environment or uninstalling the application from the computer system according to the authentication result.

18. The machine-readable medium of claim 17, further comprising instructions which, when executed by the processor, causing the processor to:
prior to the authenticating the identification data, obtain a login credential of the computer system after having detected a system event;
request a service to authenticate the identification data in the trusted environment; and
perform the service after having verified a privilege of the login credential.

19. The machine-readable medium of claim 17, further comprising instructions which, when executed by the processor, causing the processor to:
store a definition file and a policy file as the predetermined rule in the trusted environment, wherein the definition file includes a feature associated with a type of applications, and the policy file includes an instruction to allow the type of applications to be installed or prevent the type of applications from being installed in the trusted environment.

20. The machine-readable medium of claim 19, further comprising instructions which, when executed by the processor, causing the processor to:
compare the identification data with the definition file to determine whether the application belongs to the type of applications; and
determine whether installing the application complies with the instruction of the policy file if the application belongs to the type of applications.

21. The machine-readable medium of claim 17, further comprising instructions which, when executed by the processor, causing the processor to:
receive a file for updating the predetermined rule;
validate a content of the file in the trusted environment; and
based on a result of the validation, update the predetermined rule according to the file in the trusted environment.
